(19) United States
(12) Patent Application Publication
(10) Pub. No.: US 2026/0126813 A1
(43) Pub. Date: May 7, 2026

(54) VEHICLE AND METHOD FOR ESTIMATING AND UPDATING TRAJECTORY BASED ON ERROR DYNAMICS

(71) Applicant: Blue Origin, LLC, Kent, WA (US)

(72) Inventor: Lloyd Strohl, Kent, WA (US)

(21) Appl. No.: 18/939,312

(22) Filed: Nov. 6, 2024

(51) Int. Cl. G05D 1/654

(52) U.S. Cl. CPC G05D 1/6545

(57) ABSTRACT

An improved vehicle and method to efficiently compute trajectory dynamics by estimating error between a reference trajectory and state kinematics is described herein. The vehicle is configured to obtain a first expected state at a first time and a second expected state at a second time after the first time based on a reference trajectory and using Hermite polynomial interpolation; linearize dynamics associated with the reference trajectory to obtain a linear model of error dynamics for the vehicle; before the second time, estimate a first error between a state of the vehicle at the second time and an expected state at the second time if a trajectory of the vehicle remains unchanged; update the reference trajectory to account for the first error using the linear model of error dynamics; and cause a guidance system of the vehicle to adjust the trajectory according to commands generated based on the updated trajectory.

### TECHNICAL FIELD

The present disclosure generally relates to optimizing trajectories of vehicles.

### BACKGROUND

Vehicles that operate in space may have capabilities to land on a surface of a target destination. The vehicles may be able to determine a trajectory for landing by using a combination of onboard sensors and pre-programmed algorithms. The vehicles may follow a predetermined trajectory based on mission planning and simulations. As the vehicles approach a designated landing site, the vehicles may follow the trajectory for landing at the designated landing site.

### SUMMARY OF THE INVENTION

The systems, methods, and devices described herein each have several aspects, no single one of which is solely responsible for its desirable attributes. Without limiting the scope of this disclosure, several non-limiting features will now be discussed briefly.

One aspect of the disclosure provides a vehicle. The vehicle comprises a non-transitory data store storing computer-executable instructions. The vehicle further comprises a processor in communication with the non-transitory data store, wherein the computer-executable instructions, when executed by the processor, configure the processor to: obtain a first expected state of the vehicle at a first time and a second expected state of the vehicle at a second time after the first time based on a reference trajectory and using Hermite polynomial interpolation; linearize dynamics associated with the reference trajectory to obtain a linear model of error dynamics for the vehicle; before the second time, estimate a first error between a state of the vehicle at the second time and the second expected state of the vehicle at the second time if a trajectory of the vehicle remains unchanged; update the reference trajectory to account for the first error using the linear model of error dynamics; and cause a guidance system of the vehicle to adjust the trajectory of the vehicle according to commands generated based on the updated trajectory.

The vehicle of the preceding paragraph can include any sub-combination of the following features: where the computer-executable instructions, when executed by the processor, further cause the processor to cause the guidance system of the vehicle to adjust the trajectory of the vehicle at the second time according to commands generated based on the updated trajectory, where the trajectory is adjusted to have a position of the vehicle match the reference trajectory at a third time; where the computer-executable instructions, when executed by the processor, further cause the processor to cause the vehicle to adjust the trajectory according to the updated trajectory for ascent operations, changing orbits, or descent operations of the vehicle; where the first expected state and the second expected state comprises desired position, velocity, thrust, and mass over time; where the computer-executable instructions, when executed by the processor, further cause the processor to, before the second time, estimate the first error between the state of the vehicle at the second time and the second expected state of the vehicle at the second time according to computing kinematic dynamics of the vehicle between the first time and the second time; where the computer-executable instructions, when executed by the processor, further cause the processor to update the reference trajectory to account for the first error using the linear model of error dynamics without recomputing full nonlinear dynamics of the trajectory; where the computer-executable instructions, when executed by the processor, further cause the processor to: perform interpolation of the first expected state and the second expected state to determine a third expected state of the vehicle at a third time that is between the first time and the second time, before the third time, estimate a second error between a state of the vehicle at the third time and the third expected state if the trajectory of the vehicle remains unchanged, update the reference trajectory to account for the second error using the linear model of error dynamics, and cause the guidance system of the vehicle to adjust the trajectory of the vehicle by the third time according to commands generated based on the updated trajectory;

Another aspect of the disclosure provides computer-implemented method comprising the steps of obtaining a first expected state of a vehicle at a first time and a second expected state of the vehicle at a second time after the first time based on a reference trajectory and using Hermite polynomial interpolation; linearizing dynamics associated with the reference trajectory to obtain a linear model of error dynamics for the vehicle; before the second time, estimating a first error between a state of the vehicle at the second time and the second expected state of the vehicle at the second time; updating the reference trajectory to account for the first error using the linear model of error dynamics; and causing a guidance system of the vehicle to adjust a trajectory of the vehicle according to commands generated based on the updated trajectory.

The computer-implemented method of the preceding paragraph can include any sub-combination of the following features: where causing the guidance system of the vehicle to adjust the trajectory of the vehicle according to commands generated based on the updated trajectory further comprises causing the guidance system of the vehicle to adjust the trajectory of the vehicle at the second time according to commands generated based on the updated trajectory, where the trajectory is adjusted to have a position of the vehicle match the reference trajectory at a third time; where causing the guidance system of the vehicle to adjust the trajectory of the vehicle according to commands generated based on the updated trajectory further comprises causing the vehicle to adjust the trajectory of the vehicle according to commands generated based on the updated trajectory for ascent operations, changing orbits, or descent operations of the vehicle; where before the second time, estimating the first error between the state of the vehicle at the second time and the second expected state of the vehicle at the second time further comprises, before the second time, estimating the first error between the state of the vehicle at the second time and the second expected state of the vehicle at the second time according to computing kinematic dynamics of the vehicle between the first time and the second time; where updating the reference trajectory to account for the first error using the linear model of error dynamics further comprises updating the reference trajectory to account for the first error using the linear model of error dynamics without recomputing full nonlinear dynamics of the trajectory; where before the second time, estimating the first error between the state of the vehicle at the second time and the second expected state of the vehicle at the second time further comprises, before the second time, estimating the first error between the state of the vehicle at the second time and the second expected state of the vehicle at the second time if a trajectory of the vehicle remains unchanged; where the method further comprising: performing interpolation of the first expected state and the second expected state to determine a third expected state of the vehicle at a third time that is between the first time and the second time, before the third time, estimating a second error between a state of the vehicle at the third time and the third expected state if the trajectory of the vehicle remains unchanged, updating the reference trajectory to account for the second error using the linear model of error dynamics, and causing the guidance system of the vehicle to adjust the trajectory of the vehicle by the third time according to commands generated based on the updated trajectory.

Another aspect of the disclosure provides non-transitory, computer-readable storage media comprising computer-executable instructions for computing linearized dynamics of a vehicle, wherein the computer-executable instructions, when executed by a computer system, cause the computer system to obtain a first expected state of the vehicle at a first time and a second expected state of the vehicle at a second time after the first time based on a reference trajectory and using Hermite polynomial interpolation; linearize dynamics associated with the reference trajectory to obtain a linear model of error dynamics for the vehicle; before the second time, estimate a first error between a state of the vehicle at the second time and the second expected state of the vehicle at the second time if a trajectory of the vehicle remains unchanged; update the reference trajectory to account for the first error using the linear model of error dynamics; and cause a guidance system of the vehicle to adjust a trajectory of the vehicle according to commands generated based on the updated trajectory.

The non-transitory, computer-readable storage media of the preceding paragraph can include any sub-combination of the following features: where the computer-executable instructions further cause the computer system to cause the guidance system of the vehicle to adjust the trajectory of the vehicle at the second time according to commands generated based on the updated trajectory, where the trajectory is adjusted to have a position of the vehicle match the reference trajectory at a third time; where the computer-executable instructions further cause the computer system to cause the vehicle to adjust the trajectory according to the updated trajectory for ascent operations, changing orbits, or descent operations of the vehicle; where the computer-executable instructions further cause the computer system to, before the second time, estimate the first error between the state of the vehicle at the second time and the second expected state of the vehicle at the second time according to computing kinematic dynamics of the vehicle between the first time and the second time; where the computer-executable instructions further cause the computer system to update the reference trajectory to account for the first error using the linear model of error dynamics without recomputing full nonlinear dynamics of the trajectory; where the computer-executable instructions further cause the computer system to: perform interpolation of the first expected state and the second expected state to determine a third expected state of the vehicle at a third time that is between the first time and the second time, before the third time, estimate a second error between a state of the vehicle at the third time and the third expected state if the trajectory of the vehicle remains unchanged, update the reference trajectory to account for the second error using the linear model of error dynamics, and cause the guidance system of the vehicle to adjust the trajectory of the vehicle by the third time according to commands generated based on the updated trajectory.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is an example spacecraft maneuver environment in accordance with aspects of the present disclosure.

FIG. 2 is a block diagram depicting an example operating environment in which a spacecraft guidance, navigation, and control system can compute error dynamics of a vehicle in accordance with aspects of the present disclosure.

FIG. 3A is an example spacecraft maneuver environment in accordance with aspects of the present disclosure.

FIG. 3B flow diagrams depicting example interactions for updating a reference trajectory according to error dynamics of a vehicle in accordance with aspects of the present disclosure.

FIG. 4 is a flow chart depicting an example routine for updating a reference trajectory according to error dynamics of a vehicle in accordance with aspects of the present disclosure.

FIG. 5 is a block diagram depicting a general architecture of a computing device that is configured to provide efficient computation of updated reference trajectories in accordance with aspects of the present disclosure.

### DETAILED DESCRIPTION

The present disclosure relates to efficiently computing updates to a spacecraft trajectory and causing the spacecraft to adjust the trajectory accordingly. Advantageously, the systems described herein apply a linear error propagation technique to efficiently determine error at future time steps between a reference trajectory and actual state values of the spacecraft. In this way, the spacecraft may update a reference trajectory according to the error dynamics, in order to provide responsive guidance commands for spacecraft maneuvers. For example, the spacecraft maneuvers may include performing ascent operations, changing orbit, and descent operations. Conventional systems compute the reference trajectory by estimating nonlinear kinematic solutions to the spacecraft dynamics using various analytical approximations. Estimating the nonlinear kinematic solutions in this way may result in some error as part of the approximation. Current mission requirements have error thresholds for estimating states of the nonlinear kinematic solutions, which may be on the order of 10⁻⁴ for any given state (position, velocity, acceleration, thrust, etc.), depending on the mission requirements. The systems disclosed herein provide for efficient computation of spacecraft dynamics to enhance trajectory determination and reduce error for determining a reference trajectory.

Existing systems update a reference trajectory for spacecraft maneuvers by recomputing nonlinear dynamics according to changed state parameters (such as position, velocity, mass, thrust, etc.). Nonlinear kinematic dynamics provide a mathematical model of the spacecraft during flight along the reference trajectory. For example, modeling the acceleration of the spacecraft may account for nonlinear equations of motion according to the position, velocity, and thrust of the spacecraft. The low-rate computation techniques are used to solve nonlinear kinematic dynamics of the spacecraft while following the reference trajectory. Computing nonlinear kinematic dynamics is resource intensive due to the complexity of solving for numerous variables modeling the dynamics of the spacecraft. In this way, existing spacecraft that take into account nonlinear dynamics produce results at a low rate of speed (for example, existing spacecraft utilize a low-rate computation technique). However, spacecraft travel at high speeds and rely on high-rate guidance updates at a speed to accurately guide the spacecraft while performing various maneuvers, thus low-rate computation techniques may produce results too slowly for an existing spacecraft to effectively take advantage of the results produced to guide the spacecraft.

One approach to overcome the slow computation time is to compute a series of discrete reference trajectory points using the low-rate computation techniques and interpolate between the points to estimate values representing states of the spacecraft. For example, the existing spacecraft may compute the series of discrete reference trajectory points using the low-rate computation techniques such that the total period of time corresponding to the discrete reference trajectory points is greater than the time it takes for the existing spacecraft to compute the discrete reference trajectory points using the low-rate computation techniques. The existing spacecraft can then interpolate between the discrete reference trajectory points such that the time difference between each successive interpolated point is sufficient to accurately guide the spacecraft (for example, the time difference is equivalent to the existing spacecraft computing the reference trajectory at a high rate of speed). Some conventional approaches apply an interpolation wrapper around the low-rate computation techniques to interface with the high-rate guidance system. In this way, if the spacecraft were perfectly following the reference trajectory, then the spacecraft could simply interpolate on the trajectory into the future to extract new initial conditions for a next time step.

However, the spacecraft will not be perfectly following the trajectory due to various error sources including (but not limited to): navigation error, control tracking error, and error in spacecraft dynamics. When the spacecraft attempts to land, for example, even minor errors may result in inaccurate descent, which may cause the spacecraft to be outside a safe zone for the descent trajectory. Additionally, although quicker than recomputing nonlinear dynamics, interpolating still results in a computational delay and inaccuracies given that the interpolated points are merely an estimation. In some situations, the computational delay between requesting a new trajectory update and receiving the interpolation from the low-rate computation technique could lead to the trajectory being out of date by the time the spacecraft sought to apply the interpolation.

Some aspects of the present disclosure address some or all of the technical issues noted above, among others, by efficiently computing a spacecraft trajectory using linearized error dynamics. For example, the systems described herein may use Hermite polynomial interpolation to interpolate the low-rate trajectory points, linearize error dynamics around the reference trajectory to efficiently propagate current state error forward in time, and use the linear error propagation to update the reference trajectory, rather than fully recomputing the nonlinear dynamics. The use of linear error propagation bridges the gap between a computationally complex low-rate computation and the need for responsive high-rate guidance commands. Rather than fully recomputing the nonlinear spacecraft dynamics every time a new trajectory update is required, the system linearizes the error between the current state and the reference trajectory. The linear error dynamics model is then used to efficiently propagate the error forward in time. This allows the system to update the reference trajectory without having to resolve the full nonlinear dynamics, providing the high-rate guidance commands needed for maneuvers like precision landing. Advantageously, computing spacecraft maneuvering using a linearized technique leverages the optimality of the low-rate computation while enabling the responsive control required for challenging spaceflight operations.

Additional aspects of the present disclosure relate to propagating initial conditions of a navigation state forward by a known delay using internal dynamic models and a previous guidance solution. In this way, the trajectory would be aligned with the spacecraft's state. When the low-rate trajectory optimizer generates a new optimal path for the spacecraft, there is an inherent delay before the spacecraft can act. Rather than simply using the spacecraft's current state to start following the new trajectory, the systems disclosed herein use a simple coast dynamics model to predict where the spacecraft will be in a few seconds. Then, when the new trajectory solution is computed, the system anticipates an additional few seconds before the spacecraft can execute the solution to compensate for computation time. Instead of trying to immediately transition to the new trajectory, the guidance system linearizes the dynamics around the reference path and propagates the error state forward in time to when the new trajectory is expected to complete computation. This allows the system to blend a new trajectory with the spacecraft's predicted state, avoiding possible discontinuities in the guidance commands. By anticipating the computation time required, the systems disclosed herein can maintain smooth, responsive control throughout a maneuver, even as the optimal trajectory is updated.

Various aspects of the disclosure will now be described with regard to certain examples and embodiments, which are intended to illustrate but not limit the disclosure. Although aspects of some embodiments described in the disclosure will focus, for the purpose of illustration, on particular examples of spacecraft state determination, trajectory optimization, and estimating computing resources, the examples are illustrative only and are not intended to be limiting. In some embodiments, the techniques described herein may be applied to additional or alternative computing environments, spacecraft state determination, trajectory optimization, and estimating computing resources, and the like. Additionally, any feature used in any embodiment described herein may be used in any combination with any other feature or in any other embodiment, without limitation.

### Example Conventional Spacecraft Landing System

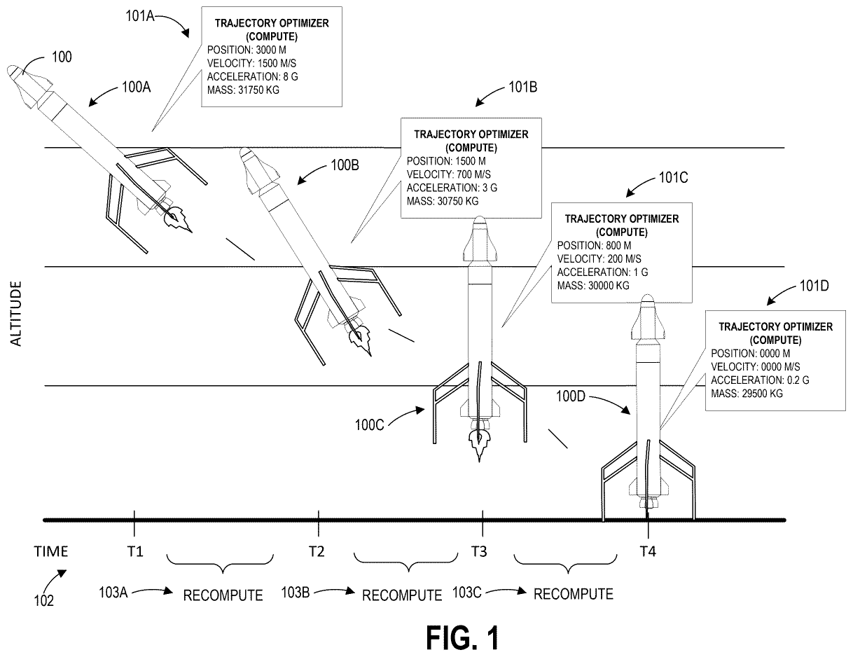

Some conventional approaches recompute nonlinear dynamics of a spacecraft trajectory during a maneuver. To illustrate the conventional approach, FIG. 1 depicts a spacecraft 100 attempting a landing maneuver. The spacecraft 100 attempts to adjust a position along a time duration, for example, adjusting to a series of positions 100A, 100B, 100C, 100D over a time axis 102. The spacecraft 100 may be a space lander, a rover, a rocket, a satellite, a spaceship, a space shuttle, and/or any other type of vehicle that is capable of operating in space and/or on an extraterrestrial object other than Earth. At a first time, the spacecraft 100 has begun a descent to a surface of a target destination. The spacecraft 100 has initiated engines to produce thrust against acceleration due to gravity to slow the descent of the spacecraft 100. Between the first time and the second time, the spacecraft 100 perform a first recompute 103A of nonlinear dynamics according to the first state 101A of the spacecraft. For example, the first state 101A of the first position 100A of the spacecraft 100 includes position, velocity, acceleration, and mass, in some cases there will be more or fewer states to monitor. As an example, the first state 101A includes values such as a position of 3000 meters (m), a velocity of 1500 meters/second (m/s), an acceleration of 8-g, and a mass of 31750 kilograms (kg).

At a second time, the spacecraft 100 continues the descent to the surface of the target destination. The spacecraft 100 adjusts a position to align the spacecraft 100 for the descent. In this way, the engines of the spacecraft 100 produces thrust against acceleration due to gravity to slow the descent of the spacecraft 100. Between the second time and the third time, the spacecraft 100 performs a second recompute 103B of nonlinear dynamics according to the second state 101B of the spacecraft. For example, the second state 101B of the second position 100B of the spacecraft 100 includes position, velocity, acceleration, and mass, in some cases there will be more or fewer states to monitor. As an example, the second state 101B includes values such as a position of 1500 m, a velocity of 700 m/s, an acceleration of 3-g, and a mass of 30750 kg.

At a third time, the spacecraft 100 continues the descent to the surface of the target destination. The spacecraft 100 adjusts a position to align the spacecraft 100 laterally for landing. In this way, the engines of the spacecraft 100 produces thrust against acceleration due to gravity to slow even further the descent of the spacecraft 100. Between the third time and the fourth time, the spacecraft 100 performs a third recompute 103C of nonlinear dynamics according to the third state 101C of the spacecraft. For example, the third state 101C of the third position 100C of the spacecraft 100 includes position, velocity, acceleration, and mass, in some cases there will be more or fewer states to monitor. As an example, the third state 101C includes values such as a position of 800 m, a velocity of 200 m/s, an acceleration of 1-g, and a mass of 30000 kg.

At a fourth time, the spacecraft 100 completes the descent to the surface of the target destination. The spacecraft 100 adjusts a position of the spacecraft 100 for landing. In this way, the engines of the spacecraft 100 produces thrust against acceleration due to gravity to slow even further the descent of the spacecraft 100. At the fourth time, the spacecraft 100 computed the final state values of nonlinear dynamics according to the fourth state 101D of the spacecraft. For example, the fourth state 101D of the fourth position 100D of the spacecraft 100 includes position, velocity, acceleration, and mass, in some cases there will be more or fewer states to monitor. As an example, the fourth state 101D includes values such as a position of 0 m, a velocity of 0 m/s, an acceleration of 0.2-g, and a mass of 29500 kg. The changes of the state values corresponds with the spacecraft 100 consuming fuel to perform the maneuvers as discussed for each of the positions of the spacecraft 100. For example, the mass reduces over time due to the use of fuel (for example, burning solid/liquid propellant) to adjust thrust for reducing acceleration of the spacecraft 100. The final acceleration reflects the acceleration due to gravity of the target destination (for example, the acceleration due to gravity on the lunar surface is 0.2-g).

### Example Spacecraft Guidance, Navigation, and Control System

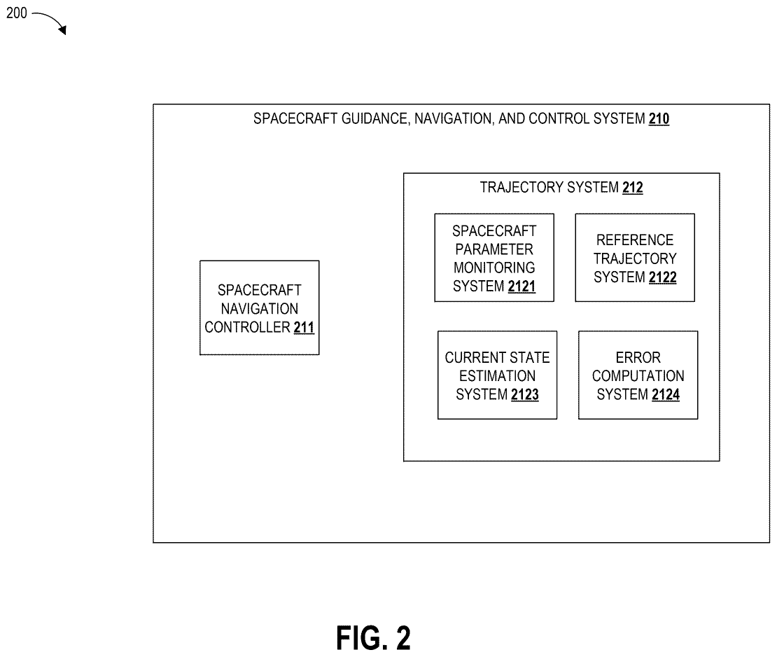

FIG. 2 is a block diagram of an example operating environment 200 in which a spacecraft guidance, navigation, and control (GNC) system 210 may provide efficient computation of a spacecraft trajectory using an error linearization technique. The spacecraft GNC system 210 may include a spacecraft navigation controller 211 and a trajectory system 212 and may be present onboard a spacecraft.

The spacecraft navigation controller 211 may generate instructions to control position of the spacecraft. In some examples, the spacecraft navigation controller 211 may include standalone systems of the spacecraft GNC system 210, embedded systems designed and programmed to receive inputs from various systems (and subsystems) of the spacecraft to provide instructions that cause positional adjustments of the spacecraft. The spacecraft navigation controller 211 may be an embedded system, for example designed and programmed on a field-programmable gate array (FPGA) or application-specific integrated circuit (ASIC) or another form of embedded system, which may be responsible for generating instructions and executing high-rate guidance and control algorithms. In some cases, the spacecraft navigation controller 211 may include executable instructions that allow the spacecraft navigation controller 211 to receive reference trajectory points from the low-rate trajectory optimization system. In response to receiving the trajectory points, the spacecraft navigation controller 211 may generate the high-rate guidance commands and send the guidance commands to the spacecraft's attitude and thrust control systems, ensuring smooth, responsive control throughout the maneuver. By implementing this functionality in a dedicated embedded controller, the system can provide low-latency, high-bandwidth control required for spacecraft operations, for example, precision landing. In this way, the use of FPGA or ASIC hardware enables real-time (or substantially real-time) performance and reliability needed for these safety-critical applications.

The trajectory system 212 may be implemented as a high-performance computing platform, potentially leveraging parallel processing architectures like FPGAs or ASICs, to handle the computationally intensive techniques. In some embodiments, the trajectory system 212 may have various configurations of processing power, memory, storage, and networking capacity according to spacecraft GNC architecture. In this way, the trajectory system 212 may include a spacecraft parameter monitoring system 2121, reference trajectory system 2122, current state estimation system 2123, and error computation system 2124.

The spacecraft parameter monitoring system 2121 may interface with various sensors to measure vehicle parameter values of the spacecraft. For example, the spacecraft parameter monitoring system 2121 may monitor vehicle parameter values such as position, velocity, acceleration, thrust, mass, attitude, data synchronization, and any other state value parameters for monitoring the spacecraft. In some examples, the spacecraft parameter monitoring system 2121 may integrate data from global positioning system (GPS) receivers, inertial measurement units (IMUs), and potentially other navigation aids to produce a high-precision estimate of the spacecraft's position (for example, three degree-of-freedom (3DoF) or more) and corresponding velocity. In this way, the spacecraft parameter monitoring system 2121 may apply filtering techniques (such as Kalman filtering) implemented in custom FPGA or ASIC hardware to combine the sensor data and provide low-latency, high-bandwidth state updates.

In some examples, the spacecraft parameter monitoring system 2121 may monitor acceleration and thrust. In this way, the spacecraft parameter monitoring system 2121 may process data from accelerometers and thrust sensors to determine the spacecraft's instantaneous acceleration and the magnitude of the thrust generated by a propulsion system of the spacecraft. The spacecraft parameter monitoring system 2121 may include dedicated digital signal processing (DSP) cores to perform real-time (or substantially real-time) signal processing and state estimation.

In some examples, the spacecraft parameter monitoring system 2121 may estimate mass properties of the spacecraft. For example, the spacecraft parameter monitoring system 2121 may combine acceleration and thrust measurements with other state data to estimate mass properties. In some cases, the spacecraft parameter monitoring system 2121 may estimate the spacecraft's mass properties, including total mass and center of mass location. In this way, the spacecraft parameter monitoring system 2121 may provide trajectory planning and control.

In some examples, the spacecraft parameter monitoring system 2121 may determine an attitude of the spacecraft. In this way, the spacecraft parameter monitoring system 2121 may apply gyroscopes, star trackers, and/or other attitude sensors. The spacecraft parameter monitoring system 2121 may determine the spacecraft's orientation in 3D space. In this way, the spacecraft parameter monitoring system 2121 may apply quaternion-based attitude estimation algorithms optimized for embedded implementation on FPGA (or another embedded system) fabric.

In some examples, the spacecraft parameter monitoring system 2121 may provide a cohesive, synchronized view of the spacecraft's state. In this way, the spacecraft parameter monitoring system 2121 may integrate the various sensor measurements to align the sensor values in time and applying sensor fusion techniques to produce a unified state estimate.

The reference trajectory system 2122 may execute algorithms that generate the optimal reference trajectory for the spacecraft (for example, convex optimization algorithms). The reference trajectory system 2122 may compute the reference trajectory according to the spacecraft propulsion, aerodynamics, and mission constraints to produce a series of discrete waypoints defining desired position, velocity, acceleration, and other relevant states (or trajectories) over time.

The current state estimation system 2123 may integrate data from the spacecraft's sensor suite, including IMUs, GPS receivers, and other navigation aids. Using the sensor monitoring techniques described herein, the current state estimation system 2123 may compute a real-time (or substantially real-time) estimate of the spacecraft's current position, velocity, attitude, and other states. The current state estimation system 2123 may apply Hermite polynomial interpolation techniques to determine the spacecraft state values between discrete reference trajectory points. In this way, the current state estimation system 2123 may generate smooth, continuous state trajectories at an updated rate.

The error computation system 2124 may compute and linearize the error dynamics around the reference trajectory. The error computation system 2124 may apply the current state estimate and the reference trajectory to compute a linear model of the error propagation, enabling efficient prediction of the future state error. For example, when a new optimal trajectory is computed by the low-rate guidance application, the error computation system 2124 may apply the linearized error propagation to blend the new trajectory with the spacecraft's predicted state, ensuring smooth, continuous guidance commands. By implementing these key functions in dedicated hardware modules, the trajectory system can provide the low-latency, high-throughput performance required to support the high-rate guidance and control of the spacecraft during critical maneuvers like precision landing.

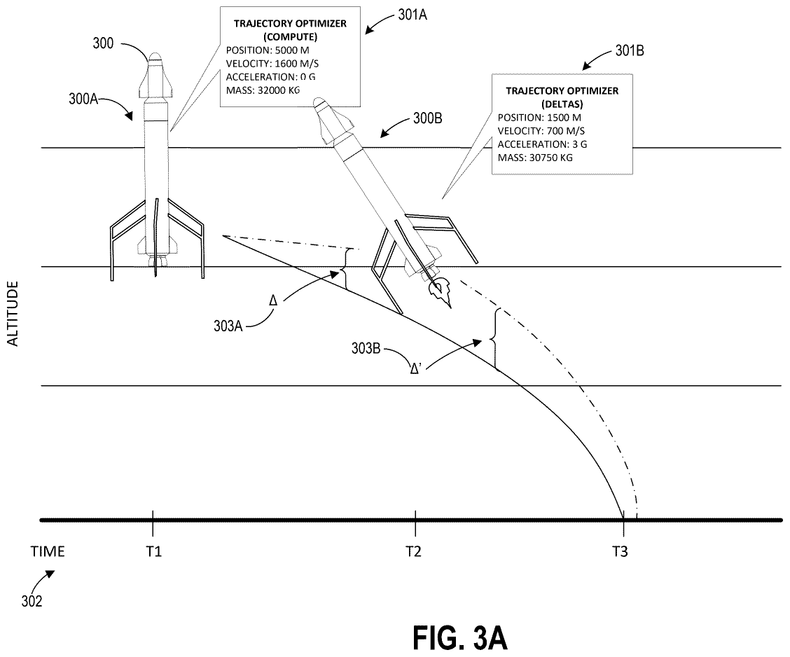

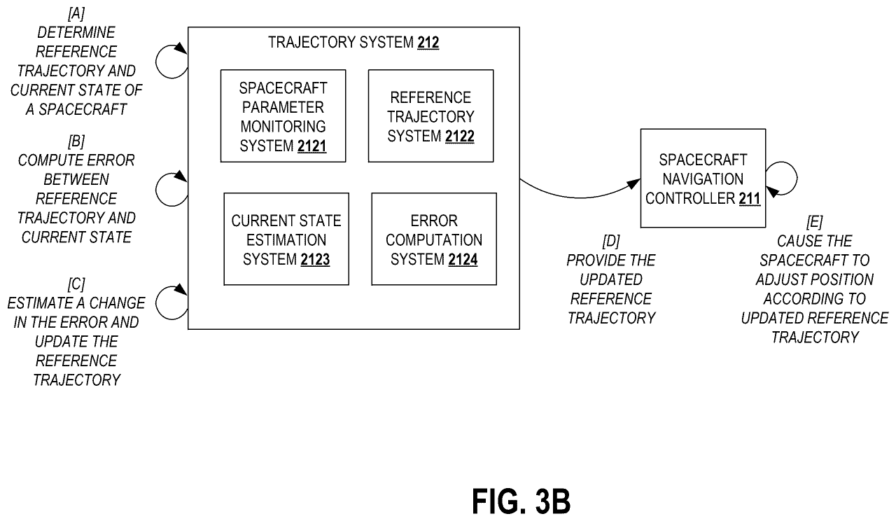

FIG. 3A illustrates an example spacecraft maneuver environment, where the spacecraft that includes the spacecraft guidance, navigation, and control system 210 efficiently computes a trajectory using linearized error dynamics. As illustrated, a spacecraft 300 may obtain a reference trajectory (as illustrated with a solid line), along which to follow for a descent to a surface of a target destination. However, the spacecraft 300 may divert from the reference trajectory (as illustrated with a dashed line). At a first time (T1 as illustrated), the spacecraft 300 begins a descent to the surface of the target destination. In this way, the spacecraft 300 begins accelerating towards the surface after entering a gravitational pull of the target destination (such as the lunar surface), the spacecraft 300 initiates engines to produce thrust against the acceleration due to gravity to slow the descent of the spacecraft 300. The spacecraft 300 obtain a first state 301A at the first position 300A, which includes position, velocity, acceleration, and mass, in some cases there may be more or fewer states to monitor. As an example, the first state 301A includes values such as a position (5000 m from a target location), a velocity of 1600 m/s, an acceleration of 0-g (due to the spacecraft 300 continuing to orbit the target destination), and a mass of 32000 kg.

The spacecraft 300 may attempt to adjust a position during a time period, for example, adjusting from position 300A to position 300B during a time period between T1 and T2 along time axis 302. Between the first time and a second time (T2 as illustrated), the spacecraft 300 performs a computation of an error between the reference trajectory and estimated state of the spacecraft 300. For example, the spacecraft 300 may determine a first error 303A which indicates a difference between the reference trajectory and an estimated state of the spacecraft 300, as discussed in more detail herein.

At a second time (T2 as illustrated), the spacecraft 300 continues the descent to the surface of the target destination. The spacecraft 300 adjusts a position to align the spacecraft 300 for reaching the target. In this way, the spacecraft 300 propagates the first error 303A to compute a current and future positions of the spacecraft 300. The engines of the spacecraft 300 may aligns and produce thrust to slow the descent of the spacecraft 300 based on a second state 301B and an updated trajectory according to the first error 303A. The spacecraft 300 obtains the second state 301B of the second position 300B of the spacecraft 300 includes position, velocity, acceleration, and mass, in some cases there may be more or fewer states to monitor. As an example, the second state 301B includes values such as a position of 1500 m, a velocity of 700 m/s, an acceleration of 3-g, and a mass of 30750 kg. Between the second time and the third time, the spacecraft 300 performs a computation of an error between the reference trajectory and estimated state of the spacecraft 300. For example, the spacecraft 300 may determine a second error 303B which indicates a difference between the reference trajectory and the estimated state of the spacecraft 300 at a later time. The determination of the second error 303B the spacecraft 300 may be based on the first error 303A. In this way, the spacecraft 300 may compute the updated reference trajectory according to updates to the error, rather than recomputing nonlinear spacecraft dynamics during the descent.

At a third time, the spacecraft 300 is projected to complete the descent to the surface of the target destination. The spacecraft 300 may adjust a position from the second position 300B of the spacecraft 300 for landing according to the propagated error and the actual and estimated states of the spacecraft 300. In this way, the engines of the spacecraft 300 may align and produce thrust against acceleration due to gravity to slow even further the descent of the spacecraft 300. At the third time, the spacecraft 300 may compute final state values of the spacecraft 300. For example, the final state of the spacecraft 300 includes position, velocity, acceleration, and mass, in some cases there will be more or fewer states to monitor. As an example, the final state includes values such as a position of 0 m, a velocity of 0 m/s, an acceleration of 0.2-g, and a mass of 29500 kg. In some cases, the changes of the state values correspond with the spacecraft 300 consuming fuel to perform the maneuvers as discussed for each of the positions of the spacecraft 300. For example, the mass reduces over time due to the use of fuel (for example, burning solid/liquid propellant) to adjust thrust for reducing acceleration of the spacecraft 300. The final acceleration reflects the acceleration due to gravity of the target destination (for example, the acceleration due to gravity on the lunar surface is 0.2-g).

FIG. 3B illustrates a flow diagram depicting example interactions for efficiently updating a trajectory according to linearized dynamics of a spacecraft. At [A], a trajectory system 212 determines a reference trajectory and current state of a spacecraft. The trajectory system 212 may obtain the reference trajectory from a guidance system (for example, a low-rate guidance application onboard the spacecraft or external to the spacecraft, not shown). In this way, the trajectory system 212 may interpolate values from the reference trajectory to extract instantaneous guidance commands and reference states which may be used by the spacecraft navigation controller 211 to generate instructions to adjust a position of the spacecraft. In some cases, the trajectory system 212 may interpolate future states which may be used by an error computation system (such as error computation system 2124 as illustrated in FIG. 2). In some cases, the trajectory system 212 may interpolate values during a maneuver of the spacecraft, for example, during burn time of the spacecraft when performing a landing operation. In this way, the trajectory system 212 may leverage a constant state of the spacecraft during the burn time (due to the monotonic nature of the burn time as opposed to altitude is not guaranteed to be monotonic during a primary descent phase). In some examples, the trajectory system 212 may compute the burn time according to a computation time signal, a time obtained from a GNC system (for example, as part of the spacecraft GNC system 210 in FIG. 2), and software parameters for a nominal low-rate guidance application computation time and for the delay arising from sequencer transitions. When using the burn time in this way, the trajectory system 212 may reset the burn time upon guidance updates by an update signal (for example, from a component of the spacecraft GNC system 210 in FIG. 2).

In some examples, the trajectory system 212 may interpolate the reference trajectory using Hermite polynomial interpolation. In this way, the Hermite polynomial interpolation may approximate kinematic trajectory of the spacecraft as a series of piecewise continuous polynomials which are smoothly differentiable at nodes (for example, N derivatives at the nodes are continuous). As part of the interpolation, the reference trajectory system 2122 may generate a function which computes a minimum order polynomial to interpolate between nodes of a kinematic trajectory while matching a zeroth and a first order derivative at the nodes. For example, boundary constraints on function values and first derivatives may result in four degrees-of-freedom which can be satisfied by four basis functions. Accordingly, a 3^{rd}-order polynomial provides four basis functions and the boundary constraints result in a system of four linear equations and four unknowns; the basis function coefficients. The reference trajectory system 2122 may solve for these coefficients (for example, symbolically) to return an interpolation at points between the nodes. In this way, the reference trajectory system 2122 may constrain first derivatives at the nodes, which results in the reference trajectory system 2122 satisfying the following equations:

$$y ( {t}_{k} ) = {y}_{k} \qquad ( 1 )$$

$$y ( {t}_{k + 1} ) = {y}_{k + 1} \qquad ( 2 )$$

$$\dot{y} ( {t}_{k} ) = {\dot{y}}_{k} \qquad ( 3 )$$

$$\dot{y} ( {t}_{k + 1} ) = {\dot{y}}_{k + 1} \qquad ( 4 )$$

Accordingly, the reference trajectory system 2122 may obtain a 3^{rd}-order cubic function as follows to satisfy Equations (1)-(4):

$$\overline{y} = {a}_{0} + {a}_{1} t + {a}_{2} {t}^{2} + {a}_{3} {t}^{3} \qquad ( 5 )$$

In this way, the reference trajectory system 2122 may obtain a minimum-order polynomial system of linear equations with a closed form solution which the reference trajectory system 2122 may solve symbolically, giving a cubic polynomial calculation in terms of function values and derivatives at the nodes and the query point at which to interpolate. Thus, the reference trajectory system 2122 may interpolate along the reference trajectory according to Equation (5).

In some examples, the current state estimation system 2123 may obtain current state values by receiving sensor values from various sensors onboard the spacecraft. For example, the current state estimation system 2123 may monitor vehicle parameter values such as position, velocity, acceleration, thrust, mass, attitude, data synchronization, and any other state value parameters for monitoring the spacecraft, as described herein (for example, as described with respect to the spacecraft monitoring system 2121 in FIG. 2).

At [B], the trajectory system 212 computes an error according to the reference trajectory and the current state. For example, the trajectory system 212 may determine the error from kinematic dynamics of the reference trajectory. For example, the trajectory system 212 may compute the kinematic dynamics and compare to the current state to obtain the error. In some cases, the trajectory system 212 may compute the kinematic dynamics according to whether the spacecraft has already computed the error and/or seeks to propagate the error (for example, either an initial propagation or a linear propagation technique). The trajectory system 212 may switch between the initial propagation technique and the linearized propagation technique according to whether the computed error is a first solution for the expected maneuver (such as, powered descent initiation or a subsequent mid-flight update). For illustrative purposes, the error computation according to [B] is an initial propagation, and then the change in error according to linear propagation will be described herein (for example, in [C] below).

For initial propagation, computation using a low-rate guidance application takes time. For example, computing a powered descent trajectory solution may take several seconds to complete. For example, applying the low-rate guidance application solves a two-point boundary value problem, starting from given initial conditions. If the current Moon-Centered, Moon-Fixed (MCMF) navigation state is provided as initial conditions to the low-rate guidance application, the solution will be outdated upon completion of computation. Thus, in some cases, the computation time may result in an outdated trajectory computation by the time the spacecraft relies on the computation to adjust a position. This may result in tracking error, exceeding limits of a steering controller (such as, spacecraft navigation controller 211 in FIG. 2) and lead to divergence from the feasible state space, which may cause the spacecraft to be outside of a safe trajectory for the maneuver.

To compensate for the computation time, the trajectory system 212 may propagate state values of the spacecraft forward through the expected computation time and provide predicted initial conditions to the low-rate guidance application. In this way, the trajectory system 212 may determine a propagation time (Δt) to compensate for the low-rate guidance application's computation time and sequencing delays. In some cases, the propagation time may include extra time for engine startup of the spacecraft. For example, the startup of engines at the initiation of a powered descent may take additional time past the computation time. In this way, determining the propagation time may allow for the trajectory system 212 (or other systems onboard) to confirm a feasible solution before an engine ignition signal is sent to begin the spacecraft maneuver. For example, the trajectory system 212 may propagate and request trajectory, receive solution and confirm feasibility, send ignition signal, and start following the trajectory from the low-rate guidance application. By propagating forward through the sequence, the trajectory system 212 may ensure the trajectory solution aligns with a spacecraft navigation state.

In some examples, the trajectory system 212 may estimate error for spacecraft state values along the reference trajectory based on a spacecraft dynamics model from the low-rate guidance application. For example, the trajectory system 212 may apply analytical techniques to solve for variables according to a dynamical model for a MCMF navigation state, as follows:

$$\dot{r} ( t ) = v ( t ) \qquad ( 6 )$$

$$\dot{v} ( t ) = a ( t ) \qquad ( 7 )$$

$$a ( t ) = \frac{T ( t )}{m ( t )} - μ \frac{r ( t )}{{‖ r ( t ) ‖}^{3}} - ω \times ( ω \times r ( t ) ) - 2 ω \times v ( t ) \qquad ( 8 )$$

$$\dot{m} ( t ) = - α ‖ T ( t ) ‖ \qquad ( 9 )$$

$$\dot{T} ( t ) = {\dot{T}}_{0} \qquad ( 10 )$$

Where m(t) is mass, r(t), v(t), and T(t) are position, velocity, and thrust in the MCMF frame, ω is the angular rate of the of the MCMF frame with respect to an inertial frame, α is the thrust-specific fuel consumption, and \dot{T}₀ is the initial thrust derivative.

The trajectory system 212 may estimate error for states of the spacecraft according to the solution to the above equations using analytical techniques. For example, the trajectory system 212 may estimate error (such as, for position of the spacecraft) by comparing solutions to Equations (6)-(10) using a Runge-Kutta integration (such as, a Runge-Kutta fourth order (RK4) integration) across the time step Δt to state values of the spacecraft. For example, the Runge-Kutta integration technique may include an approximation of a solution to a function (such as one or more of the Equations (6)-(10) above). For illustrative purposes, the function will include two variables y and t, as discussed below. The trajectory system 212 may compute the approximation with initial conditions of the function, such as when a variable of the function may have an initial value (such as y₀, t₀). The trajectory system 212 may compute the approximation by selecting a step size h (for example, greater than 0) and define a system of equations as follows:

$${y}_{n + 1} = {y}_{n} + \frac{h}{6} ( {k}_{1} + {k}_{2} + {k}_{3} + {k}_{4} )$$

$${t}_{n + 1} = {t}_{n} + h$$

For n=1, 2, 3, . . . using:

$${k}_{1} = f ( {t}_{n} , {y}_{n} ) ,$$

$${k}_{2} = f ( {t}_{n} + \frac{h}{2} , {y}_{n} + h \frac{{k}_{1}}{2} ) ,$$

$${k}_{3} = f ( {t}_{n} + \frac{h}{2} , {y}_{n} + h \frac{{k}_{2}}{2} ) ,$$

$${k}_{4} = f ( {t}_{n} + h , {y}_{n} + h {k}_{3} ) .$$

Where yₙ₊₁ is the RK4 approximation of y(tₙ₊₁), and the next value (yₙ₊₁) is determined by the present value (yₙ) plus the weighted average of four increments, where each increment is the product of the size of the interval, h, and an estimated slope specified by function ƒ on the right-hand side of the differential equation. k₁ is the slope at the beginning of the interval, using y (Euler's method); k₂ is the slope at the midpoint of the interval, using y and k₁; k₃ is again the slope at the midpoint, but now using y and k₂; k₄ is the slope at the end of the interval, using y and k₃. In averaging the four slopes, greater weight is given to the slopes at the midpoint. If ƒ is independent of y, so that the differential equation is equivalent to a simple integral, then RK4 is Simpson's rule. The RK4 method is a fourth-order method, meaning that the local truncation error is on the order of O(h⁵), while the total accumulated error is on the order of O(h⁴).

The trajectory system 212 may apply the equations through requisite Δt time steps using RK4 integration. The time step may correspond to the computation time for determining a trajectory solution. In some cases, the computation time for the low-rate guidance application on flight hardware is approximately two seconds, however, the computation time may be less. To ensure sufficient numerical accuracy of the integration scheme, the trajectory system 212 may subdivide the time step into minor time steps for the RK4 routine. The number of minor time steps may be associated with a target numerical accuracy. For example, the target numerical accuracy for velocity error may be less accurate than 10⁻⁵ m/s. To achieve such accuracy, the RK4 method may rely on a single time step (but in other cases, may rely on between 1 and 256 minor time steps). Using the RK4 routine, the trajectory system 212 may estimate numerical error En which may have the following relationship to the time steps:

$${∈}_{n} ∝ 1 / Δ {t}^{4}$$

Thus, the error computed using RK4 has an inverse relationship to the time steps taken. In some cases, to accommodate for the spacecraft dynamics, the trajectory system 212 may apply a plurality of RK4 steps (for example, three steps in series) with different values for \dot{T}₀ and Δt corresponding to the expected durations.

In some cases, when the spacecraft remains idle prior to performing the maneuver (to compensate for the computation time), the trajectory system 212 may instruct activation of a minimum thrust level for a fixed duration after engine start. In this way, the propagation timeline may be as follows: coast through low-rate guidance application computation time (no thrust); send ignition signal once a valid trajectory is available and coast (no thrust); engine startup transient, linear thrust ramp (non-zero \dot{T}₀); and dwell at fixed thrust magnitude.

At [C], the trajectory system 212 estimates a change in the error and updates the reference trajectory according to the error dynamics. The trajectory system 212, in this case, may apply the linearized propagation technique for determining the change in the error. For linearized propagation, the trajectory system 212 may perform guidance updates periodically during the maneuver (such as powered descent). In this case, the trajectory system 212 may still compensate for low-rate guidance application's computation time Δt (as described in [B]). During the maneuver, while the spacecraft is following a previous thrust trajectory solution provided by the low-rate guidance application, the trajectory system 212 may not reliably characterize thrust by a constant thrust or a linear thrust ramp. Thus, the trajectory system 212 may apply a full reference trajectory from the low-rate guidance application. For example, if the spacecraft were perfectly following low-rate guidance application's trajectory then the trajectory system 212 could interpolate on the trajectory Δt in the future to extract new initial conditions for future computation. However, in cases where the spacecraft does not perfectly follow the trajectory, the misaligned trajectory may be due to various error sources including, for example: navigation error, control tracking error, linearization error in low-rate guidance application dynamics.

To compute the error according to the reference trajectory, the trajectory system 212 may linearize the spacecraft dynamics about a previous reference trajectory. For example, the trajectory system 212 may compute Jacobians with respect to various state values (for example, position, velocity, and mass). In this way, the trajectory system 212 may provide results of linearized spacecraft dynamics. For example, in state-space form, with x, y, and z components of the MCMF state, the spacecraft dynamics may include the following equations:

$$x = [ \begin{matrix}r \\ v \\ m\end{matrix} ] \qquad ( 11 )$$

$$f = \dot{x} \qquad ( 12 )$$

Where r is position, v is velocity, m is mass, and ƒ is a change in the spacecraft state. Accordingly, the trajectory and the Jacobians are as follows.

$$f = [ \begin{matrix}{v}_{x} \\ {v}_{y} \\ {v}_{z} \\ \begin{matrix}2 {v}_{y} {ω}_{z} - 2 {v}_{z} {ω}_{y} + \frac{{T}_{x}}{m} + {ω}_{y} ( {r}_{x} {ω}_{y} - {r}_{y} {ω}_{x} ) + {ω}_{z} ( {r}_{x} {ω}_{z} - {r}_{z} {ω}_{x} ) - \frac{μ {r}_{x}}{{‖ r ‖}^{3}} \\ 2 {v}_{z} {ω}_{x} - 2 {v}_{x} {ω}_{z} + \frac{{T}_{y}}{m} + {ω}_{x} ( {r}_{x} {ω}_{y} - {r}_{y} {ω}_{x} ) + {ω}_{z} ( {r}_{y} {ω}_{z} - {r}_{z} {ω}_{y} ) - \frac{μ {r}_{y}}{{‖ r ‖}^{3}}\end{matrix} \\ \begin{matrix}2 {v}_{x} {ω}_{y} - 2 {v}_{y} {ω}_{x} + \frac{{T}_{z}}{m} + {ω}_{x} ( {r}_{x} {ω}_{z} - {r}_{z} {ω}_{x} ) + {ω}_{y} ( {r}_{y} {ω}_{z} - {r}_{z} {ω}_{y} ) - \frac{μ {r}_{z}}{{‖ r ‖}^{3}} \\ - α ‖ T ‖\end{matrix}\end{matrix} ] \qquad ( 13 )$$

$${J}_{r} = [ \begin{matrix}0 & 0 & 0 \\ 0 & 0 & 0 \\ 0 & 0 & 0 \\ \begin{matrix}{ω}_{y}^{2} - \frac{μ}{{‖ r ‖}^{3}} + \\ {ω}_{z}^{2} + \frac{3 μ {r}_{x}^{2}}{{‖ r ‖}^{5}}\end{matrix} & \begin{matrix}\frac{3 μ {r}_{x} {r}_{y}}{{‖ r ‖}^{5}} - \\ {ω}_{x} {ω}_{y}\end{matrix} & \begin{matrix}\frac{3 μ {r}_{x} {r}_{z}}{{‖ r ‖}^{5}} - \\ {ω}_{x} {ω}_{z}\end{matrix} \\ \begin{matrix}\frac{3 μ {r}_{x} {r}_{y}}{{‖ r ‖}^{5}} - \\ {ω}_{x} {ω}_{y}\end{matrix} & \begin{matrix}{ω}_{x}^{2} - \frac{μ}{{‖ r ‖}^{3}} + \\ {ω}_{z}^{2} + \frac{3 μ {r}_{y}^{2}}{{‖ r ‖}^{5}}\end{matrix} & \begin{matrix}\frac{3 μ {r}_{y} {r}_{z}}{{‖ r ‖}^{5}} - \\ {ω}_{y} {ω}_{z}\end{matrix} \\ \begin{matrix}\frac{3 μ {r}_{x} {r}_{z}}{{‖ r ‖}^{5}} - \\ {ω}_{x} {ω}_{z}\end{matrix} & \begin{matrix}\frac{3 μ {r}_{y} {r}_{z}}{{‖ r ‖}^{5}} - \\ {ω}_{y} {ω}_{z}\end{matrix} & \begin{matrix}{ω}_{x}^{2} - \frac{μ}{{‖ r ‖}^{3}} + \\ {ω}_{y}^{2} + \frac{3 μ {r}_{z}^{2}}{{‖ r ‖}^{5}}\end{matrix} \\ 0 & 0 & 0\end{matrix} ] \qquad ( 14 )$$

$${J}_{v} = [ \begin{matrix}1 & 0 & 0 \\ 0 & 1 & 0 \\ 0 & 0 & 1 \\ 0 & 2 {ω}_{z} & - 2 {ω}_{y} \\ - 2 {ω}_{z} & 0 & 2 {ω}_{x} \\ 2 {ω}_{y} & - 2 {ω}_{x} & 0 \\ 0 & 0 & 0\end{matrix} ] \qquad ( 15 )$$

$${J}_{m} = [ \begin{matrix}0 \\ 0 \\ 0 \\ - {T}_{x} / {m}^{2} \\ - {T}_{y} / {m}^{2} \\ - {T}_{z} / {m}^{2} \\ 0\end{matrix} ] \qquad ( 16 )$$

Where Jᵣ, Jᵥ, and Jₘ are the Jacobians of ƒ with respect to position, velocity, and mass respectively, and the angular rate of the of the MCMF frame with respect to an inertial frame is ω. The full Jacobian with respect to our position, velocity, and mass states is the concatenation of the sub-Jacobians:

$$J = [ {J}_{r} , {J}_{v} , {J}_{m} ] \qquad ( 17 )$$

The dynamics of the error e about the reference trajectory ƒₑ is then:

$${f}_{e} = J ϵ \qquad ( 18 )$$

The trajectory system 212 may propagate ƒₑ through an RK4 step to obtain the change of the error (for example, through the next Δt). The trajectory system 212 may add the error to the interpolated reference trajectory's state at the end of the time step to obtain initial conditions for a mid-maneuver update from the low-rate guidance application to obtain an updated reference trajectory.

At [D], the trajectory system 212 provides the updated reference trajectory to a spacecraft navigation controller 211. In this way, the spacecraft navigation controller 211 may generate instructions to adjust a position of the spacecraft to align with the updated reference trajectory. At [E], the spacecraft navigation controller 211 causes the spacecraft to adjust a position according to the updated reference trajectory.

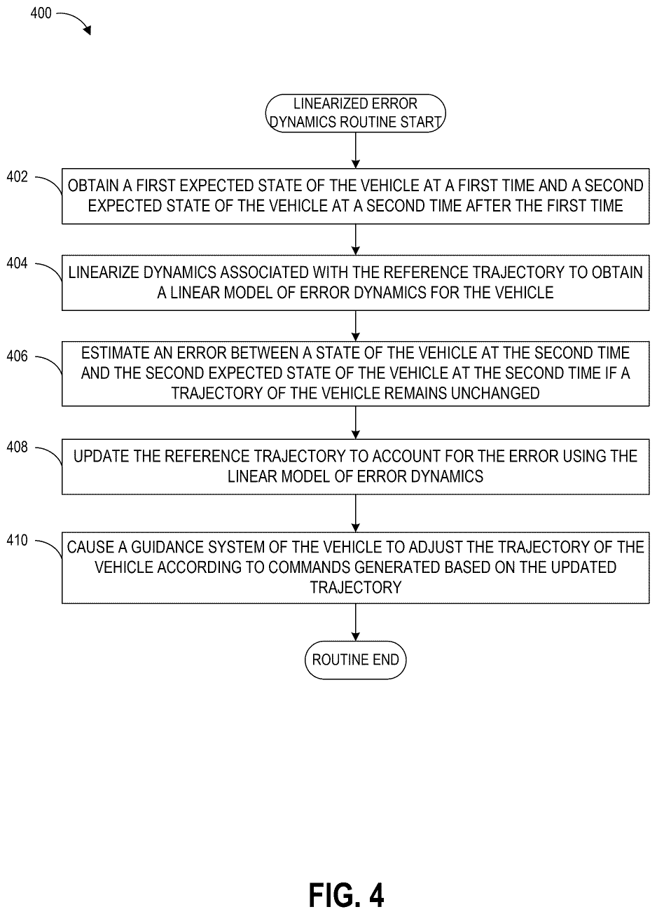

FIG. 4 is one illustrative routine 400 for efficiently computing a spacecraft trajectory using an error linearization technique. The routine 400 may be carried out, for example, by the trajectory system 212 of FIG. 2. The routine 400 begins at block 402, where the trajectory system 212 obtains approximated state values of a vehicle (for example, a spacecraft) from a low-rate trajectory optimizer. In some cases, the approximated state values of the vehicle are obtained relative to the reference trajectory using Hermite polynomial interpolation, as described herein (for example, according to the disclosure in FIG. 3B). In some examples, the reference trajectory includes an indication of an expected state of the vehicle at a first time and an expected state of the vehicle at a second time after the first time. The expected state of the vehicle may correspond to a desired position, velocity, thrust, and mass over time. In some examples, the low-rate trajectory optimizer may be associated with the low-rate guidance application, as disclosed herein. The actual state of the vehicle may correspond to actual position, velocity, thrust, and mass of the vehicle at a particular time. The vehicle may determine the actual state according to onboard sensors and techniques as disclosed herein.

At block 404, the trajectory system 212 linearizes dynamics associated with the reference trajectory to obtain a linear model of error dynamics for the vehicle. The trajectory system 212 may linearize the dynamics associated with the reference trajectory according to the techniques disclosed herein (for example, as disclosed in FIG. 3B).

At block 406, the trajectory system 212 estimates an error between a state of the vehicle at the second time and the approximated state of the vehicle at the second time. For example, before the second time, the trajectory system 212 may estimate the error between the state of the vehicle at the second time and the approximated state of the vehicle at the second time according to computing kinematic dynamics of the vehicle between the first time and the second time. In some cases, the estimation of the error occurs if a trajectory of the vehicle remains unchanged. Otherwise, the trajectory system 212 may update the error and/or reference trajectory to account for the change in trajectory. The trajectory system 212 may estimate the error according to the techniques disclosed herein (for example, as disclosed in FIG. 3B).

At block 408, the trajectory system 212 updates the reference trajectory to account for the error using the linear model of error dynamics. In some examples, the trajectory system 212 may update the reference trajectory to account for the error using the linear model of error dynamics without recomputing full nonlinear dynamics of the vehicle trajectory. In this way, the trajectory system 212 may update the reference trajectory without increased delay due to computing the full nonlinear dynamics.

At block 410, the trajectory system 212 causes a guidance system of the vehicle to adjust the trajectory of the vehicle according to commands generated based on the updated trajectory. In some examples, the trajectory system 212 may cause a guidance system of the vehicle to adjust the trajectory of the vehicle at the second time according to commands generated based on the updated trajectory. In this way, the trajectory system 212 may adjust the trajectory to have the vehicle's position match the reference trajectory at a third time. Adjusting the trajectory to match the reference trajectory at the third time may be associated with compensating for the computing time of components of the vehicle (for example, the low-rate guidance application computing the trajectory as described in FIG. 3B). In some examples, the trajectory system 212 may cause the vehicle to adjust the trajectory according to the updated trajectory for ascent operations, changing orbits, or descent operations of the vehicle. For example, the maneuvers described may rely upon a reference trajectory, and thus, may linearize the error dynamics of the vehicle to adjust the trajectory according to the disclosure herein.

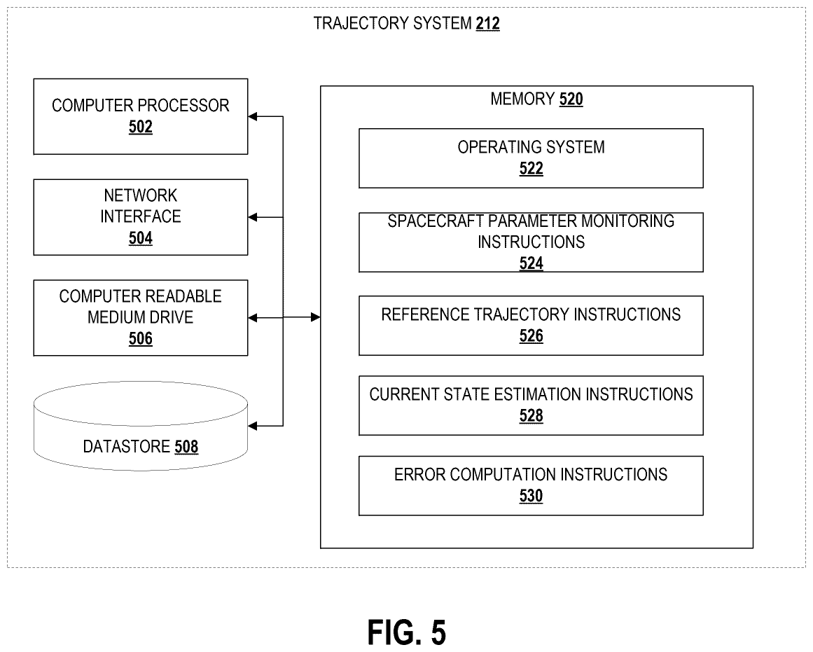

FIG. 5 illustrates various components of an example computing device configured to implement various functionality of the trajectory system 212. In some embodiments, as shown, the trajectory system 212 may include: one or more computer processors 502, such as physical central processing units (“CPUs”); one or more network interfaces 504, such as a network interface cards (“NICs”); one or more computer-readable medium drives 506, such as a high density disk (“HDDs”), solid state drives (“SSDs”), flash drives, and/or other persistent non-transitory computer-readable media; one or more datastore 508, such as physical storage and/or remote storage, and/or other data storage components; and one or more computer-readable memories 520, such as random access memory (“RAM”) and/or other volatile non-transitory computer-readable media.

The computer-readable memory 520 may include computer program instructions that one or more computer processors 502 execute in order to implement one or more embodiments. The computer-readable memory 520 can store an operating system 522 that provides computer program instructions for use by the computer processor(s) 502 in the general administration and operation of the trajectory system 212. In some embodiments, the computer-readable memory 520 can further include computer program instructions and other information for implementing aspects of the present disclosure. For example, the computer-readable memory 520 may include spacecraft parameter monitoring instructions 524 for monitoring state parameters of the spacecraft, as described herein; reference trajectory instructions 526 for obtaining a reference trajectory of the spacecraft; current state estimation instructions 528 for determining current state values of the spacecraft; and error computation instructions 530 for computing the error between the reference trajectory and actual state values of the spacecraft. When a routine is initiated, a corresponding set of executable program instructions stored on a computer-readable medium drive 506 may be loaded into computer-readable memory 520 and executed by one or more computer processors 502. In some embodiments, a routine—or portions thereof—may be implemented on multiple computing devices and/or multiple processors, serially or in parallel.

### Terminology

All of the methods and tasks described herein may be performed and fully automated by a computer system. The computer system may, in some cases, include multiple distinct computers or computing devices (for example, physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (for example, solid state storage devices, disk drives, etc.). The various functions disclosed herein may be embodied in such program instructions or may be implemented in application-specific circuitry (for example, ASICs or FPGAs) of the computer system. Where the computer system includes multiple computing devices, these devices may, but need not, be co-located. The results of the disclosed methods and tasks may be persistently stored by transforming physical storage devices, such as solid state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (for example, not all described operations or events are necessary for the practice of the algorithm). Moreover, in certain embodiments, operations or events can be performed concurrently, for example, through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (for example, ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or logic circuitry that implements a state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A vehicle comprising:
a non-transitory data store storing computer-executable instructions; and
a processor in communication with the non-transitory data store, wherein the computer-executable instructions, when executed by the processor, configure the processor to:
obtain a first expected state of the vehicle at a first time and a second expected state of the vehicle at a second time after the first time based on a reference trajectory and using Hermite polynomial interpolation;
linearize dynamics associated with the reference trajectory to obtain a linear model of error dynamics for the vehicle;
before the second time, estimate a first error between a state of the vehicle at the second time and the second expected state of the vehicle at the second time if a trajectory of the vehicle remains unchanged;
update the reference trajectory to account for the first error using the linear model of error dynamics; and
cause a guidance system of the vehicle to adjust the trajectory of the vehicle according to commands generated based on the updated trajectory.

2. The vehicle of claim 1, wherein the computer-executable instructions, when executed by the processor, further cause the processor to cause the guidance system of the vehicle to adjust the trajectory of the vehicle at the second time according to commands generated based on the updated trajectory, wherein the trajectory is adjusted to have a position of the vehicle match the reference trajectory at a third time.

3. The vehicle of claim 1, wherein the computer-executable instructions, when executed by the processor, further cause the processor to cause the vehicle to adjust the trajectory according to the updated trajectory for ascent operations, changing orbits, or descent operations of the vehicle.

4. The vehicle of claim 1, wherein the first expected state and the second expected state comprises desired position, velocity, thrust, and mass over time.

5. The vehicle of claim 1, wherein the computer-executable instructions, when executed by the processor, further cause the processor to, before the second time, estimate the first error between the state of the vehicle at the second time and the second expected state of the vehicle at the second time according to computing kinematic dynamics of the vehicle between the first time and the second time.

6. The vehicle of claim 1, wherein the computer-executable instructions, when executed by the processor, further cause the processor to update the reference trajectory to account for the first error using the linear model of error dynamics without recomputing full nonlinear dynamics of the trajectory.

7. The vehicle of claim 1, wherein the computer-executable instructions, when executed by the processor, further cause the processor to:
perform interpolation of the first expected state and the second expected state to determine a third expected state of the vehicle at a third time that is between the first time and the second time;
before the third time, estimate a second error between a state of the vehicle at the third time and the third expected state if the trajectory of the vehicle remains unchanged;
update the reference trajectory to account for the second error using the linear model of error dynamics; and
cause the guidance system of the vehicle to adjust the trajectory of the vehicle by the third time according to commands generated based on the updated trajectory.

8. A computer-implemented method comprising:
obtaining a first expected state of a vehicle at a first time and a second expected state of the vehicle at a second time after the first time based on a reference trajectory and using Hermite polynomial interpolation;
linearizing dynamics associated with the reference trajectory to obtain a linear model of error dynamics for the vehicle;
before the second time, estimating a first error between a state of the vehicle at the second time and the second expected state of the vehicle at the second time;
updating the reference trajectory to account for the first error using the linear model of error dynamics; and
causing a guidance system of the vehicle to adjust a trajectory of the vehicle according to commands generated based on the updated trajectory.

9. The method of claim 8, wherein causing the guidance system of the vehicle to adjust the trajectory of the vehicle according to commands generated based on the updated trajectory further comprises causing the guidance system of the vehicle to adjust the trajectory of the vehicle at the second time according to commands generated based on the updated trajectory, wherein the trajectory is adjusted to have a position of the vehicle match the reference trajectory at a third time.

10. The method of claim 8, wherein causing the guidance system of the vehicle to adjust the trajectory of the vehicle according to commands generated based on the updated trajectory further comprises causing the vehicle to adjust the trajectory of the vehicle according to commands generated based on the updated trajectory for ascent operations, changing orbits, or descent operations of the vehicle.

11. The method of claim 8, wherein before the second time, estimating the first error between the state of the vehicle at the second time and the second expected state of the vehicle at the second time further comprises, before the second time, estimating the first error between the state of the vehicle at the second time and the second expected state of the vehicle at the second time according to computing kinematic dynamics of the vehicle between the first time and the second time.

12. The method of claim 8, wherein updating the reference trajectory to account for the first error using the linear model of error dynamics further comprises updating the reference trajectory to account for the first error using the linear model of error dynamics without recomputing full nonlinear dynamics of the trajectory.

13. The method of claim 8, wherein before the second time, estimating the first error between the state of the vehicle at the second time and the second expected state of the vehicle at the second time further comprises, before the second time, estimating the first error between the state of the vehicle at the second time and the second expected state of the vehicle at the second time if a trajectory of the vehicle remains unchanged.

14. The method of claim 8, further comprising:
performing interpolation of the first expected state and the second expected state to determine a third expected state of the vehicle at a third time that is between the first time and the second time;
before the third time, estimating a second error between a state of the vehicle at the third time and the third expected state if the trajectory of the vehicle remains unchanged;
updating the reference trajectory to account for the second error using the linear model of error dynamics; and
causing the guidance system of the vehicle to adjust the trajectory of the vehicle by the third time according to commands generated based on the updated trajectory.

15. Non-transitory, computer-readable storage media comprising computer-executable instructions for computing linearized dynamics of a vehicle, wherein the computer-executable instructions, when executed by a computer system onboard the vehicle, cause the computer system to:
obtain a first expected state of the vehicle at a first time and a second expected state of the vehicle at a second time after the first time based on a reference trajectory and using Hermite polynomial interpolation;
linearize dynamics associated with the reference trajectory to obtain a linear model of error dynamics for the vehicle;
before the second time, estimate a first error between a state of the vehicle at the second time and the second expected state of the vehicle at the second time if a trajectory of the vehicle remains unchanged;
update the reference trajectory to account for the first error using the linear model of error dynamics; and
cause a guidance system of the vehicle to adjust a trajectory of the vehicle according to commands generated based on the updated trajectory.

16. The non-transitory, computer-readable storage media of claim 15, wherein the computer-executable instructions further cause the computer system to cause the guidance system of the vehicle to adjust the trajectory of the vehicle at the second time according to commands generated based on the updated trajectory, wherein the trajectory is adjusted to have a position of the vehicle match the reference trajectory at a third time.

17. The non-transitory, computer-readable storage media of claim 15, wherein the computer-executable instructions further cause the computer system to cause the vehicle to adjust the trajectory according to the updated trajectory for ascent operations, changing orbits, or descent operations of the vehicle.

18. The non-transitory, computer-readable storage media of claim 15, wherein the computer-executable instructions further cause the computer system to, before the second time, estimate the first error between the state of the vehicle at the second time and the second expected state of the vehicle at the second time according to computing kinematic dynamics of the vehicle between the first time and the second time.

19. The non-transitory, computer-readable storage media of claim 15, wherein the computer-executable instructions further cause the computer system to update the reference trajectory to account for the first error using the linear model of error dynamics without recomputing full nonlinear dynamics of the trajectory.

20. The non-transitory, computer-readable storage media of claim 15, wherein the computer-executable instructions further cause the computer system to:
perform interpolation of the first expected state and the second expected state to determine a third expected state of the vehicle at a third time that is between the first time and the second time;
before the third time, estimate a second error between a state of the vehicle at the third time and the third expected state if the trajectory of the vehicle remains unchanged;
update the reference trajectory to account for the second error using the linear model of error dynamics; and
cause the guidance system of the vehicle to adjust the trajectory of the vehicle by the third time according to commands generated based on the updated trajectory.
